(19) United States
(12) Patent Application Publication
(10) Pub. No.: US 2014/0019927 A1
(43) Pub. Date: Jan. 16, 2014

(54) WAFERLESS MEASUREMENT RECIPE

(71) Applicants: Chee Kiong KOO, Singapore (SG); Qun Ying LIN, Singapore (SG)

(72) Inventors: Yasri YUDHISTIRA, Eindhoven (NL); Chee Kiong KOO, Singapore (SG); Qun Ying LIN, Singapore (SG)

(73) Assignee: GLOBALFOUNDRIES SINGAPORE PTE. LTD., Singapore (SG)

(21) Appl. No.: 13/545,011

(22) Filed: Jul. 10, 2012

(51) Int. Cl. G06F 17/50

(52) U.S. Cl. 716/112

(57) ABSTRACT

Embodiments relate to a method for manufacturing and processing semiconductor devices or integrated circuits (IC) and in particular to the generation of measurement recipes in the manufacturing of the semiconductor devices or ICs. The method comprises defining a sampling plan, mapping target locations of a device contained in the sampling plan to an article/a wafer having a plurality of said devices, verifying the mapping file and processing the verification to produce a measurement recipe. In one embodiment, the measurement recipe is created without having the actual processed wafer.

### BACKGROUND

Photolithographic techniques are used to form various IC features on a wafer. As the trends in integrated circuit fabrication follow Moore's Law and feature sizes become smaller and smaller, the use of optical enhancements such as optical proximity correction (OPC) becomes increasingly important.

As such, the ability to verify the success of OPC is critical to ramp-up production of new process technologies. Scanning Electron Microscopes (SEMs) are imaging tools which are capable of measuring feature sizes in any part of a chip, either in a test structure or within a circuit, thereby aiding in verification of success of OPC. Generation of CD-SEM recipes, however, can be complex and time-consuming, especially in view of the increasing number of targets for OPC data collection.

### SUMMARY

Embodiments relate to a method for manufacturing and processing semiconductor devices or integrated circuits (IC) and in particular to the generation of measurement recipes in the manufacturing of the semiconductor devices or ICs. The method comprises defining a sampling plan, mapping target locations of a device contained in the sampling plan to an article having a plurality of said devices, verifying the mapping file and processing the verification to produce a measurement recipe.

In one embodiment, the article comprises a wafer and the measurement recipe is created without having the actual processed wafer. In one embodiment, the sampling plan is defined by providing a file containing the layout artwork of the wafer/IC, providing a file containing locations/sites of the wafer/IC where measurements are to be performed, and inspecting the site file with respect to the layout artwork file.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. Various embodiments of the present invention are described with reference to the following drawings, in which:

FIG. 1 shows an embodiment of a process for measurement recipe creation;

FIG. 2 shows an embodiment of a method for defining a sampling plan for measurement recipe creation;

FIG. 3 shows an embodiment of a method for generating a mapping file for measurement recipe creation;

FIG. 4 shows an embodiment of a post processing stage for the measurement recipe; and

FIG. 5 shows an embodiment of data analysis for measurement recipe creation.

### DETAILED DESCRIPTION

Embodiments generally relate to manufacturing and processing of articles, such as semiconductor devices or integrated circuits. For example, devices can be any type of devices, such as memory devices including dynamic random access memories (DRAMs), static random access memories (SRAMs), non-volatile memories including programmable read-only memories (PROMs) and flash memories, optoelectronic devices, logic devices, communication devices, digital signal processors (DSPs), microcontrollers, or system-on-chip. Embodiments can also be used to manufacture other types of articles. For example, articles can include devices such as microelectromechanical systems (MEMS) and liquid crystal display (LCD) panels. The devices can be incorporated in various types of products. Such products, for example, include cell phones, personal digital assistants, computers or other electronic products.

In one embodiment, a method for producing measurement recipes in the manufacturing of articles is provided. The article, for example, may comprise a wafer. Measurement recipes, for example, may be used to identify critical dimensions defects in the article resulting from the manufacturing process. Measurement recipes, in one embodiment comprise CD-SEM recipes. In another embodiment, other types of measurement recipes are also useful. CD-SEM recipes, for example, are employed in manufacturing of semiconductor or other types of devices. In one embodiment, the measurement recipe is created without having the actual article, such as a printed or processed wafer.

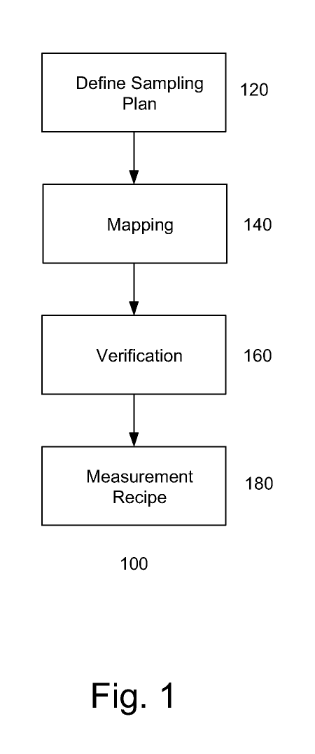

FIG. 1 shows an embodiment of a process 100 for creating the measurement recipe. At step 120, a sampling plan is defined. Defining the sampling plan may include determining the locations/sites on the article/wafer where measurements are to be performed. The interested locations or targets, for example, may relate to areas or hot spots of the article or wafer where defects are prone to occur. In one embodiment, the sampling plan comprises locations of measurements to be performed on a device. The device, for example, comprises a semiconductor device. In other embodiments, other types of devices may also be used.

In one embodiment, the device is fabricated in parallel to increase throughput. For example, the device is formed on a wafer along with numerous other devices. The wafer may be a semiconductor wafer used in fabricating semiconductor devices. Typically, the wafer can have hundreds or thousands of devices formed in parallel. The wafer is diced to separate the devices into individual devices or dies. The dies are assembled and packaged.

At step 140, the target locations of a device contained in the sampling are mapped to the article having a plurality of devices which are formed in parallel. In one embodiment, the locations contained in the sampling plan are mapped to the plurality of devices on the wafer. For example, a reference point or marker can be provided for each device. Locations may be aligned to the reference points. The coordinates of the wafer can be stored in a mapping file. Mapping can be performed manually, automatically by software tool or a combination thereof The software tool may be developed internally or it may comprise commercial software. The mapping file may be formatted into a compatible format, if appropriate, for use by a verification tool. The mapping file may be formatted by a conversion tool. Various types of conversion tools, for example, KLA software, can be employed.

The mapping file is verified at step 160 by a checker. Verification, for example, comprises performing a simulation of the manufacturing process of the article/wafer based on models. In one embodiment, the verification comprises performing an OPC check. The OPC checker produces a checker file with the verified measurement locations. The checker file, for example, is formatted in a format that is compatible to a measurement recipe generator (MRG). In one embodiment, the OPC checker produces an Extensible Markup Language (XML) file. In other embodiments, other types of output file may be provided. The OPC checker may comprise an OPC checker Graphical User Interface (GUI) for converting the data from DWM to XML, so as to facilitate acceptance of the data by later measurement tools. For example, data from DWM format may be converted to XML format for subsequent conversion to CD-SEM data format. Conversion into other data format may also be useful.

In one embodiment, at step 180, MRG processes the checker file to produce a measurement recipe. The MRG comprises CAD2SEM data conversion, i.e., the conversion of data from XML to CD-SEM to be used for later measurements. In one embodiment, the MRG processes the checker file to produce a CD-SEM recipe. In other embodiments, other types of measurement recipes may also be created. The CD-SEM recipe may comprise target coordinates and corresponding measurement algorithms, algorithm being the measurement settings when performing measurement of, for example, line, space, threshold, etc.

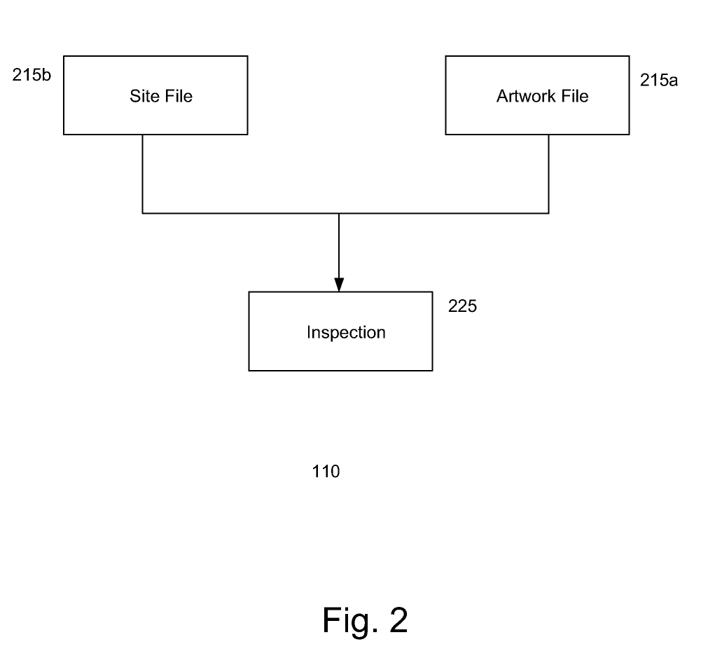

FIG. 2 shows an embodiment of a method for defining a sampling plan 110. At step 215a, a file containing the artwork of the article/wafer is provided. In one embodiment, the file comprises a database file containing layout artwork of an integrated circuit (IC). The artwork file contains layout information of the IC. The database file, for example, can be a Graphic Data System (GDS or GDS II) file. Other types of artwork files, such as OASIS, can also be employed for different embodiments. While GDS is in 2D format, different level GDS may be shown differently. In other embodiments, 3D formats may also be useful.

At step 215b, a file containing locations or sites of the IC where measurements are to be performed is provided. For example, the file contains locations/sites of features to be measured. In one embodiment, the file comprises a spreadsheet (SS) file. In other embodiments, other types of files, for example, Excel, may be provided. The interested locations or targets, for example, may relate to areas or hot spots of the IC where defects are prone to occur. The locations/sites may be in the form of 2-dimensional (x-y) coordinates. Such coordinates designate specific locations on the IC, for example, a point on the IC. Associated with the locations/sites may be the type of measurements to be performed, for example, measurement of structures such as line, space, and/or contact hole. The file may contain numerous target locations. For example, a file may contain about ten thousand (10K) target locations. Providing other number of locations may also be useful. In other embodiments, sampling reduction may be performed to reduce measurement locations so as to minimize engineering time. Sampling reduction may be done by engineering manual justification to reduce measurement points.

In one embodiment, the location/site definition in the SS file is inspected with respect to the artwork file at step 225. Inspection, for example, comprises manual checking to ensure that the coordinates of the site definition are located correctly. Alternatively, for example, in the case where SS file is generated with a SS generation tool, the verification process may be omitted.

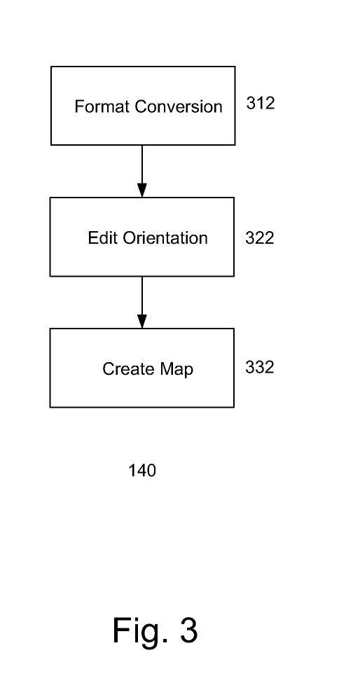

FIG. 3 shows an embodiment of a method for generating a mapping file 140. At step 312, the sampling plan is converted into a format which is compatible with the verification tool. In one embodiment, the format conversion is performed by a converter. The converter, for example, converts the sampling plan into a converted file having a database management (DBM) format.

At step 322, the converted file is analyzed to determine if the orientation of the target locations need to be adjusted. For example, some features of interest may have horizontal orientations. Others may have vertical orientations. In one embodiment, features that have a horizontal orientation are changed to a vertical orientation to be aligned with the measurement tool orientation. In other embodiments, features with a horizontal orientation are left as is.

A mapping process is performed at step 332. The mapping process extracts measurement locations of the device and builds a mapping file with target locations which correspond to locations on one, some or all devices formed in parallel. In one embodiment, the mapping process builds a wafer map to map coordinates from the artwork file (e.g., GDS coordinates) to wafer coordinates. The devices on the wafer are known. Using reference locations of the devices, the GDS coordinates can be shifted or transformed to correspond to one, some or all devices on the wafer. The wafer map may also include appropriate field size of the measurement location as well as corresponding measurement algorithm. Measurement algorithm is the parameters set in the tool, when measurements are performed, to affect the measurement outcome.

In one embodiment, the mapping process comprises setting reference coordinates of the devices on the wafer. The reference coordinates may be used to calculate the shift or coordinate transformation for the wafer map. The coordinate transformation may be performed by automation through software. The coordinates can be stored into a file, such as a dynamic windows memory (DWM) type file. In other embodiments, the coordinate may be stored in other types of files. Alternatively, the coordinates are entered into a checker through a GUI. For example, the coordinates may be entered into the OPC checker GUI. The field size and measurement algorithm may also be stored in a DWM file.

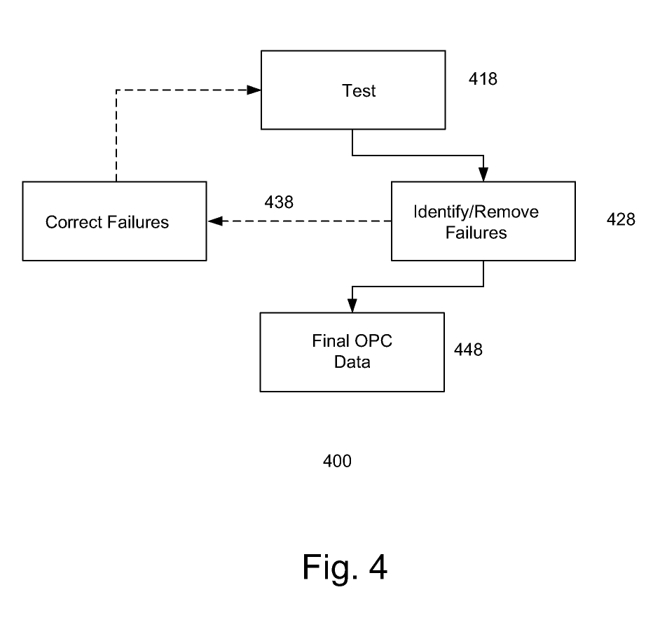

FIG. 4 is an embodiment of a post-processing stage 400 of the measurement recipe. At step 418, the measurement recipe is tested to determine whether the intended target locations are measured and to test out the measurement job file built for the particular structures. In one embodiment, the measurement recipe is loaded onto a measurement tool controller. The controller causes the measurement tool, such as a CD-SEM tool, to perform the desired measurements at the target locations of a processed wafer as defined in the recipe. In other embodiments, a CDAFM or OCD tool may be used instead. The wafer and measurement tool may be aligned to ensure that the coordinates are aligned to the target locations on the wafer.

At step 428, targets which failed to be measured are identified and removed from the recipe. In one embodiment, the recipe is then split into individual recipes with multiple targets to split the job into smaller tasks so as to ensure a higher success rate. To split the recipe, the “main” recipe can be duplicated and amended to contain the desired individual target. The main recipe is manually split out, and the individual split recipes will be measured individually. Data analysis is performed to define the final data file for OPC at step 448.

In an alternative embodiment, identified failures at step 428 are not removed from the recipe. Instead failed targets are analyzed and corrected at step 438. The modified recipe is post-processed as described.

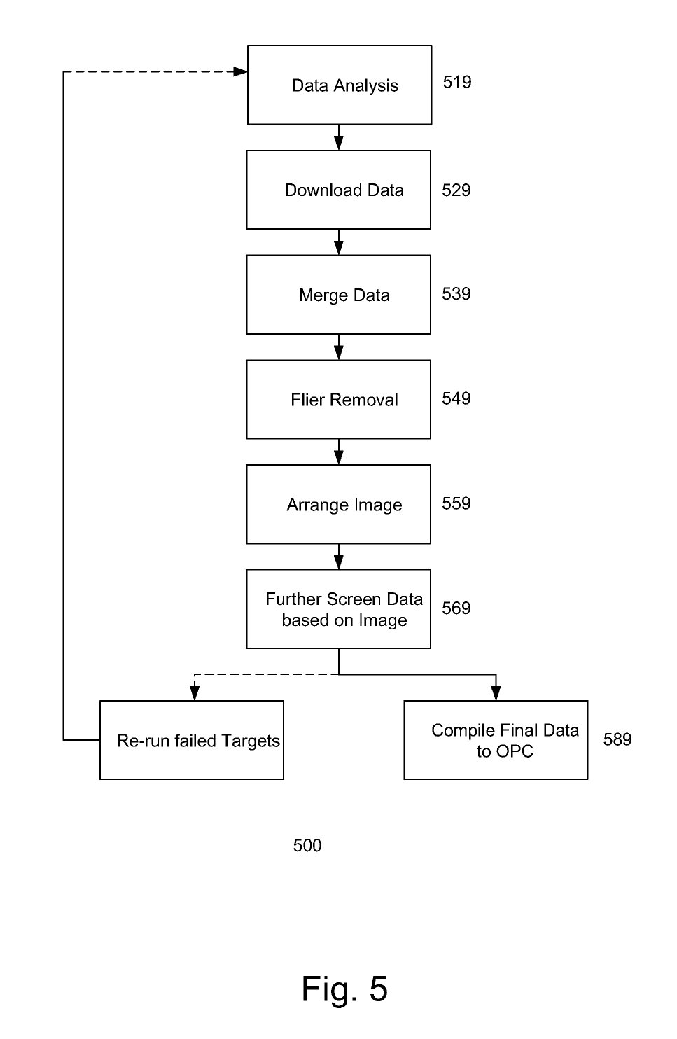

FIG. 5 shows an embodiment of data analysis process 500 to produce a final data file for OPC. At step 519, data and images are obtained for analysis. For example, at step 529, the data and images are downloaded from a measurement tool server and sent to a PC for data analysis. The images may be top down CD-SEM images and the data may be CD measurement data. For a semiconductor device, the images and data can be significant. For example, for each level, the size can be about 2GB. In one embodiment, a routine is provided for packing the images to be downloaded at one time. Another routine can be provided to unpack the data and image files. The downloaded measurement data may be merged at step 539 to provide whole data in order to analyze overall data. As there are many data sheets, several report files of data may be automatically merged to prevent confusion and help speed up processing time.

Once the data is merged, it is processed at Flier Removal step 549 to remove unreliable or abnormal data. This may be performed by 3 sigma-filtering, which means any data out of 3 sigma range will be considered bad data and removed. Alternatively, fliers or points that are out of bounds may be automatically marked and removed for processing by Image Arrangement step 559. During image arrangement, images are arranged in the right locations on the wafer. Images that have been arranged are then further sent for screening based on top down CD-SEM images in step 569. Such screening may be done manually or automatically. The purpose is to screen for poor images so they may be removed.

In another embodiment, screening may be integrated with the flier removal process so that whether a point is out of bound is based on calculation and any out of bound data or flier is automatically removed from the images to produce a final clean spreadsheet. The final clean spreadsheet needs to be in the original SS file format. This is performed by step 589, where the final data is compiled to be compatible for OPC modeling purposes. This may be done manually or automatically. In another embodiment, it may be integrated with the screening and flier removal steps so that the produced data following flier removal is in SS format. Any data that failed screening may be restarted and run again as shown in FIG. 5; alternatively, it may be discarded.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for forming a device comprising:
defining a sampling plan for testing the device;
mapping target locations on the device to a wafer having a plurality of said devices formed on the wafer based on the sampling plan, wherein the target locations are contained in a mapping file;
providing the mapping file to a checker tool to verify verifying the mapping file; processing the mapping file by a measurement recipe generator (MRG) to produce a measurement recipe;
loading the measurement recipe to a measurement tool for performing measurements on the wafer based on the measurement recipe; and
processing the wafer, wherein processing the wafer comprises dicing the wafer into individual devices.

2. The method of claim 1 wherein the measurement recipe is created without having the actual processed wafer.

3. The method of claim 2 wherein defining the sampling plan comprising:
providing a file containing the layout artwork of the wafer;
providing a file containing locations/sites of the wafer where measurements are to be performed; and
inspecting the location/site file with respect to the layout artwork file.

4. The method of claim 3 wherein the file containing locations/sites of the wafer where measurements are to be performed comprises a spreadsheet file.

5. The method of claim 1 wherein defining the sampling plan comprises determining the locations on the wafer where measurements are to be performed.

6. The method of claim 5 wherein the locations on the wafer where measurements are to be performed relate to areas/hot spots where defects are prone to occur.

7. The method of claim 1 wherein the plurality of devices on the wafer may be formed in parallel.

8. The method of claim 7 wherein each device among the plurality of devices on the wafer is given a reference point or marker, and the target locations are aligned to the reference points or markers.

9. The method of claim 1 wherein the checker tool sets reference coordinates of the mapping file to calculate the shift or coordinate transformation for a map on the wafer.

10. The method of claim 9 wherein the checker tool comprises an OPC checker tool.

11. (canceled)

12. (canceled)

13. The method of claim 1 further comprising testing the measurement recipe to determine whether the intended target locations are measured and removing targets that failed to be measured from the recipe.

14. The method of claim 13 wherein the measurement recipe is split into individual recipes with multiple targets to ensure a higher success rate.

15. A method for forming a device comprising:
defining a sampling plan for testing the device;
mapping target locations on the device to a wafer having a plurality of said devices formed on the wafer based on the sampling plan, wherein the target locations are contained in a mapping file;
providing the mapping file to a checker to verify the mapping file; processing the mapping file by a measurement recipe generator (MRG) to produce a measurement recipe, wherein the measurement recipe is created without having the actual processed wafer;
loading the measurement recipe to a measurement tool for performing measurements on the wafer based on the measurement recipe; and
processing the wafer, wherein processing the wafer comprises dicing the wafer into individual devices.

16. The method of claim 15 wherein defining the sampling plan comprising:
providing a file containing the layout artwork of the wafer;
providing a file containing locations/sites of the wafer where measurements are to be performed; and
inspecting the location/site file with respect to the layout artwork file.

17. The method of claim 15 wherein defining the sampling plan comprises determining the locations on the wafer where measurements are to be performed.

18. The method of claim 17 wherein the locations on the wafer where measurements are to be performed relate to areas/hot spots where defects are prone to occur.

19. The method of claim 15 wherein the checker sets reference coordinates of the mapping file to calculate the shift or coordinate transformation for a map on the wafer.

20. A method for measuring a device comprising:
defining a sampling plan for determining locations on a wafer where measurements are to be performed, wherein the locations where measurements are to be performed relate to areas/hot spots where defects are prone to occur;
mapping target locations on the device to the wafer, wherein the wafer has a plurality of said devices formed on the wafer based on the sampling plan, wherein the target locations are contained in a mapping file;
providing the mapping file to a checker to verify the mapping file; and
processing the mapping file by a measurement recipe generator (MRG) to produce a measurement recipe, wherein the measurement recipe is created without having the actual processed wafer; and
loading the measurement recipe to a measurement tool for performing measurements on the wafer based on the measurement recipe.

21. The method of claim 1 wherein:
the mapping file comprises a first format; and
the MRG converts the mapping file from the first format to CD-SEM format for use by a CD-SEM measurement tool, wherein the measurement tool comprises a CD-SEM tool.

22. The method of claim 21 wherein the first format comprises a XML format.
